(19) United States
(12) Patent Application Publication
(10) Pub. No.: US 2020/0183375 A1
(43) Pub. Date: Jun. 11, 2020

(54) DATA COLLECTION DEVICE FOR MANUFACTURING DEVICE

(71) Applicant: FANUC CORPORATION, Minamitsuru-gun (JP)

(72) Inventor: Shogo INOUE, Yamanashi (JP)

(21) Appl. No.: 16/701,617

(22) Filed: Dec. 3, 2019

(30) Foreign Application Priority Data
Dec. 10, 2018 (JP) 2018-231063

(51) Int. Cl. G05B 23/02

(52) U.S. Cl. CPC G05B 23/0264; G05B 23/0227

(57) ABSTRACT

A data collection device includes: a first data collection unit that receives bulk data in which a plurality of pieces of first data acquired periodically are collected; a second data collection unit that receives streaming data which is second data acquired sporadically; a data compiling unit that divides a plurality of pieces of first data received collectively and included in the bulk data into individual pieces of data so as to individually provide time stamps to the pieces of first data and that individually provides time stamps to the pieces of second data; and a chronological data alignment unit that aligns both types of data based on the time stamps.

This application is based on and claims the benefit of priority from Japanese Patent Application No. 2018-231063, filed on 10 Dec. 2018, the content of which is incorporated herein by reference.

### BACKGROUND OF THE INVENTION

### Field of the Invention

The present invention relates to a data collection device for a manufacturing device.

### Related Art

Conventionally, in order to analyze the operation conditions of a machine for industry such as a machine tool, an industrial machine or a robot and a manufacturing device including a numerical controller of the machine for industry, a data collection device is present which collects data from the manufacturing device at specific periods.

Specifically, for example, a technology is known in which numerical controllers are made to individually correspond to a plurality of machine tools, and in which the state data of the corresponding machine tool is acquired.

For example, in order to grasp the operation conditions of a machine tool, a numerical controller which acquires, at short periods, chronological data related to the torque command of a spindle, the number of revolutions of the spindle, the signal of turning on and off of the rotation of the spindle, vibration (acceleration), the signal of turning on and off of a coolant and the like in the machine tool stores the chronological data in a temporary storage device (buffer), and then the numerical controller transmits, to a data collection device, the chronological data stored in the temporary storage device. On the other hand, when chronological data is acquired periodically, for example, every minute or every second from various sensors such as a temperature sensor, a voltage sensor, an illumination sensor, an image sensor and a vibration sensor, each time the chronological data is acquired, the chronological data is transmitted to a data collection device.

In this respect, for example, patent document 1 discloses a technology in which in a machine tool, state data from a part sensor is stored in a memory, and in which when a certain amount of state data is accumulated, the state data accumulated is collectively transmitted to a host computer.
Patent Document 1: Japanese Patent No. 4763811

### SUMMARY OF THE INVENTION

Although in order to grasp the operation conditions of a manufacturing device, it is necessary to acquire various types of data, depending on the types of data, acquisition periods of data on the side of the manufacturing device are different, for example, data related to various types of control quantities and state quantities acquired in a numerical controller and data acquired in various types of sensors and various types of monitoring devices installed in a machine tool are different in acquisition period.

In such a case, it has so far been difficult for the side of a data collection device to receive bulk data in which periodic data acquired on the side of the manufacturing device is collectively transmitted and streaming data in which each time sporadic data is acquired on the side of the manufacturing device, the sporadic data is transmitted and to compile both types of data according to the time of occurrence.

An object of the present invention is to provide a data collection device that can collect data of bulk transfer in which data occurring periodically in a manufacturing device is collected and transmitted and data of streaming transfer in which, each time data occurs sporadically, the data is transmitted and that can compile a plurality of types of data according to the time of occurrence.

(1) A data collection device according to the present invention includes: a first data collection unit that receives bulk data in which a plurality of pieces of first data acquired periodically in a manufacturing device are collected and transferred in bulk; a second data collection unit that receives streaming data in which, each time a piece of second data is acquired sporadically in the manufacturing device, the piece of second data is transferred in a streaming manner; a data compiling unit that divides the pieces of first data received collectively and included in the bulk data into individual pieces of data so as to individually provide time stamps to the pieces of first data and that individually provides time stamps to the pieces of second data; and a chronological data alignment unit that aligns the pieces of first data and the pieces of second data based on the time stamps so as to convert the pieces of first data and the pieces of second data into chronological data.

(2) Preferably, in the data collection device described in (1), the time stamps of the pieces of first data are time stamps at times when the pieces of first data are acquired in the manufacturing device.

(3) Preferably, in the data collection device described in (1) or (2), the time stamps of the pieces of second data are time stamps at times when the pieces of second data are acquired in the manufacturing device.

(4) Preferably, in the data collection device described in (1) or (2), the time stamps of the pieces of second data are time stamps at times when the pieces of second data are received in the data collection device.

(5) Preferably, the data collection device described in (1) to (4), further includes: a chronological data transmission unit that transmits the chronological data to a display device which displays the chronological data.

(6) Preferably, the data collection device described in (1) to (5), further includes: a chronological data storage unit that stores the chronological data.

According to the present invention, it is possible to collect data of bulk transfer in which data occurring periodically in a manufacturing device is collected and transmitted and data of streaming transfer in which, each time data occurs sporadically, the data is transmitted and to compile a plurality of types of data.

### BRIEF DESCRIPTION OF THE DRAWINGS

FIG. 1 is an overall configuration diagram of a data collection system according to an embodiment of the present invention;

FIG. 2 is a functional block diagram of a data collection device according to the embodiment of the present invention;

FIG. 3 is a diagram showing an example of provision of time stamps in the embodiment of the present invention;

FIG. 4 is a schematic diagram of the data processing method of the data collection device according to the embodiment of the present invention;

FIG. 5 is a flowchart showing the operation of the data collection device according to the embodiment of the present invention;

FIG. 6A is a diagram showing a specific example of the operation of the data collection device according to the embodiment of the present invention; and

FIG. 6B is a diagram showing the specific example of the operation of the data collection device according to the embodiment of the present invention.

### DETAILED DESCRIPTION OF THE INVENTION

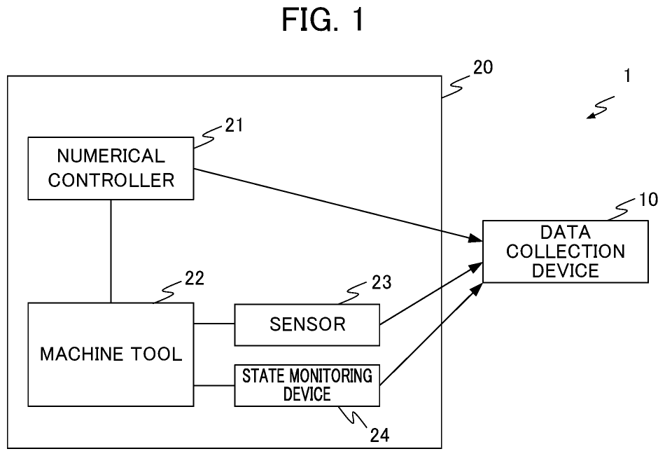

An embodiment of the present invention will be described below with reference to FIGS. 1 to 5B.

### 1 Overall Configuration

FIG. 1 is an overall configuration diagram of a data collection system 1 according to present embodiment. The data collection system 1 includes a data collection device 10 and a manufacturing device 20. Here, the manufacturing device 20 includes a numerical controller 21 and a machine tool 22, and in the machine tool 22, a sensor 23 and a state monitoring device 24 are installed. The manufacturing device 20 is not limited to this configuration. For example, the manufacturing device 20 may include a PLC (Program Logic Control) device for controlling an industrial machine and the industrial machine or a RC (Robot Control) device for controlling a robot and the robot. Although FIG. 1 shows a configuration in which one data collection device 10 is connected to one manufacturing device 20, and more specifically shows a configuration in which one data collection device 10 is connected to one numerical controller 21 included in the manufacturing device 20 and to one sensor 23 and one state monitoring device 24 installed in one machine tool 22, this configuration is an example, and there is no limitation to this configuration. The data collection device 10 can be connected to an arbitrary number of manufacturing devices 20, that is, can be connected to an arbitrary number of numerical controllers 21 and to an arbitrary number of sensors 23 and an arbitrary number of state monitoring devices 24 installed in an arbitrary number of machine tools 22. The data collection device 10 may be connected directly or through a network to the numerical controller 21, the sensor 23 and the state monitoring device 24 so as to be able to communicate therewith. Furthermore, the numerical controller 21 may include a control unit 11 and a chronological data storage unit 15 which form the data device 10.

Although in the following discussion, an example is described where the data collection device 10 collects data related to a control quantity and a state quantity in the numerical controller 21 and data related to a state quantity in the machine tool 22 which are included in the manufacturing device 20, there is no limitation to this configuration.

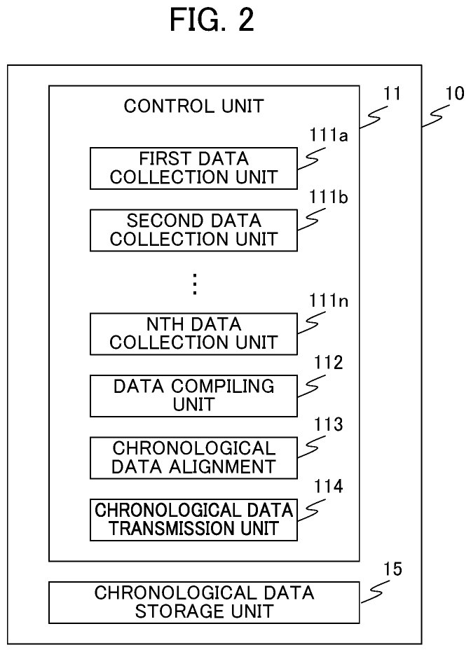

The data collection device 10 collects, from the numerical controller 21, the data related to the state quantity acquired by the numerical controller 21 and the data related to the control quantity by the numerical controller 21, and also collects the data related to the state quantity from the sensor 23 and the state monitoring device 24 installed in the machine tool 22 in order to grasp the operation conditions of the machine tool 22. The configuration of the data collection device 10 will be described later with reference to FIG. 2.

The numerical controller 21 is a NC (Numerical Control) device which controls the drive of a drive unit (motor) in each machine tool 22 so as to realize predetermined machining based on a machining program. The numerical controller 21 uses feedback control so as to control the drive unit in each machine tool 22.

The numerical controller 21 acquires operation state information while performing this control. Examples of the acquired operation state information include chronological motor control data of a spindle and a feed axis, and specific examples thereof include the command value of a motor current, the actual measurement value of the motor current, the command value of a motor rotation speed, the actual measurement value of the motor rotation speed and the actual measurement value of the torque of the motor.

These pieces of data are simply illustrative, and in addition, a position command included in an operation command output to the machine tool and information on the feedback control may be used as the operation state information. For example, position feedback, a position error obtained by reducing the position feedback from the position command and the like may be used as the operation state information. Signals which are input and output from an external device to the numerical controller 21 may be used as the operation state information. For example, a signal (hereinafter referred to as the “PMC signal”) which is described in a language called a ladder language in order to perform sequence control on the machine tool 22 may be used as the operation state information.

The machine tool 22 is a machine tool which performs predetermined machining such as cutting machining on a workpiece based on the operation command output by the numerical controller 21. The machine tool 22 includes an operation processing device, a storage device and an input/output device by an operator, and can be controlled by software. Although in FIG. 1, the machine tool 22 is represented by one functional block, the machine tool 22 may be a combination of a plurality of devices such as a combination of a machine tool and a numerical controller for controlling this machine tool. Examples of the machine tool 22 include a lathe, a milling machine, an electrical discharge machine, a grinding machine, a machining center and a laser machine.

The sensor 23 is directly installed in the machine tool 22 or is installed in the vicinity thereof, and measures various types of state quantities in the machine tool 22. The measurement values of the sensor 23 can be used as the operation state information. Examples of the sensor 23 include: a CCLD-type vibration sensor or a charge-type vibration sensor which detects the amount of vibration in a specific portion of the machine tool 22 itself or in the vicinity of the machine tool 22; a temperature sensor which detects a temperature; a sound collection microphone which is provided in the vicinity of the spindle or the motor bearing of the machine tool 22 so as to measure and output sound in the spindle or in the vicinity of the motor; a current sensor which detects the amount of drive current supplied to the motor or the laser diode of the machine tool 22; a voltage sensor which detects a supply voltage; an illumination sensor; and an image sensor. These sensors are installed in the optimum positions according to the types, the shapes, the specifications and the like of the machine tool 22.

The state monitoring device 24 includes and uses one or a plurality of sensors so as to constantly monitor the operation state of the machine tool 22, and thereby, for example, predicts a failure of the machine tool 22 or provides notification of a maintenance period. The state monitoring device 24 determines that a failure occurs, for example, when a disturbance torque detected with a torque sensor or the amplitude of the vibration of output data of the sensor exceeds a predetermined threshold value. The state monitoring device 24 may determine, based on the internal data of control software stored in the machine tool 22, that a failure of the machine tool 22 occurs. Specifically, for example, the state monitoring device 24 detects the chipping of a tool in the machine tool 22, performs the monitoring or the trend management of a blower, monitors vibrations in the spindle or a grinding wheel axis in three directions simultaneously and detects a crack in a press mold.

Various types of data are transferred from the manufacturing device 20 to the data collection device 10.

More specifically, the manufacturing device 20 collects a plurality of pieces of periodic data acquired at relatively short periods such as several milliseconds, and transfers them to the data collection device 10 in bulk.

Examples of the bulk data which is transferred in bulk include: the torque command of the spindle; the number of revolutions of the spindle; the on/off signal of the rotation of the spindle; a vibration value (acceleration value) in a specific portion of the manufacturing device 20 or in the vicinity thereof; the on/off signal of a coolant; the output command value of the laser; and the actual output value of the laser.

On the other hand, with respect to sporadic data acquired in the manufacturing device 20 at relatively long periods such as several hundreds of milliseconds to several seconds, each time the sporadic data is acquired, the sporadic data is transferred in a streaming manner to the data collection device 10.

Examples of the streaming data which is transferred in a streaming manner include: the measurement value of the temperature; a warning that the measurement value of the temperature exceeds a threshold value; the measurement value of the current; a warning that the measurement value of the current exceeds a threshold value; the positions (displacements) of the spindle and the feed axis; information of the program being executed; the number of parts which have been machined; machining information of a cutting time and the like; operation states in an automatic operation, in a manual operation and at a stop; warning information of insulation deterioration, a battery voltage drop and the like; the rotation speed and the state of a cooling fan; and the measurement value of the temperature of the coolant.

### 2 Configuration of Data Collection Device

FIG. 2 is a functional block diagram of the data collection device 10. The data collection device 10 includes the control unit 11 and the chronological data storage unit 15.

The control unit 11 is a portion which controls the entire data collection device 10, and which reads and executes, as necessary, various types of programs from storage regions such as a ROM, a RAM, a flash memory and a hard disk (HDD) so as to realize various types of functions in the present embodiment. The control unit 11 may be a CPU. The control unit 11 includes a first data collection unit 111a, a second data collection unit 111b, . . . and the nth data collection unit 111n, a data compiling unit 112, a chronological data alignment unit 113 and a chronological data transmission unit 114. The details of these functions will be described later. In addition, the control unit 11 includes general function blocks such as a function block for controlling the entire data collection device 10 and a function block for performing communication. However, since these general function blocks are well known by a person skilled in the art, illustration and description thereof will be omitted.

The first data collection unit 111a, the second data collection unit 111b, . . . and the nth data collection unit 111n receive data transmitted by the manufacturing device 20. The first data collection unit 111a, the second data collection unit 111b, . . . and the nth data collection unit 111n may be included in the control unit 11 so as to correspond to individual types of data transmitted by the manufacturing device 20.

The data compiling unit 112 divides a plurality of pieces of periodic data included in the bulk data into individual pieces of data, and provides time stamps to these individual pieces of data. More specifically, when these pieces of periodic data are acquired in the manufacturing device 20, time stamps corresponding to times when they are acquired are provided thereto but in a case where based on the time stamps provided by the manufacturing device 20, the time stamps provided by the manufacturing device 20 to the pieces of periodic data are time stamps indicating relative times after the time when front data is acquired, the data compiling unit 112 may use the time stamps indicating the relative times so as to calculate times when the pieces of periodic data are individually acquired and to provide time stamps indicating the acquisition times themselves to the individual pieces of periodic data.

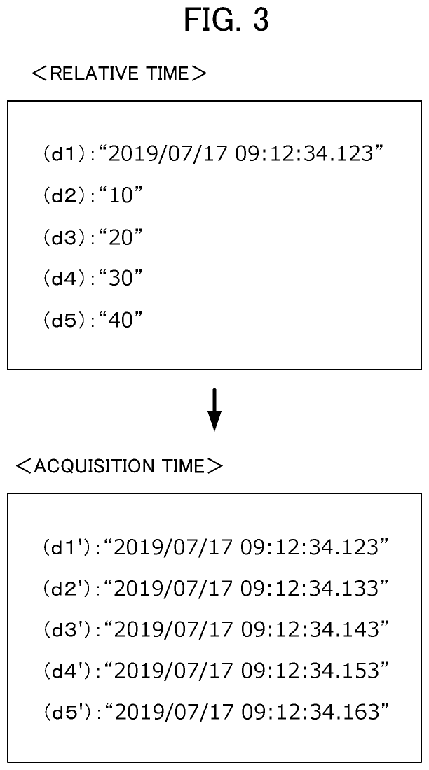

FIG. 3 shows an example of the time stamps indicating the acquisition times of data which are provided based on the time stamps indicating the relative times.

With respect to the time stamps provided by the manufacturing device 20, the time stamp for the front data (d1) is the acquisition time of the data (d1), for example, “2019/07/17 09:12:34.123”, and the time stamps for data (d2) to (d5) are relative times after the acquisition time of the data (d1) so as to be “10”, “20”, “30” and “40”. The unit of these numbers is milliseconds.

Hence, as the time stamps indicating the acquisition times of the data, the data compiling unit 112 uses, for data (d1′), the time stamp of the data (d1) as it is whereas the data compiling unit 112 respectively uses, for data (d2′) to (d5′), time stamps obtained by adding 10 milliseconds, 20 milliseconds, 30 milliseconds and 40 milliseconds to the time stamp indicting the acquisition time of the data (d1). Consequently, the time stamp provided to the data (d2′) is “2019/07/17 09:12:34.133”, the time stamp provided to the data (d3′) is “2019/07/17 09:12:34.143”, the time stamp provided to the data (d4′) is “2019/07/17 09:12:34.153” and the time stamp provided to the data (d5′) is “2019/07/17 09:12:34.163”.

The data compiling unit 112 also provides time stamps to individual pieces of sporadic data which are streaming data. These time stamps may be time stamps which indicate times when the individual pieces of sporadic data are acquired in the manufacturing device 20 or may be time stamps which indicate times when the individual pieces of sporadic data are received in the data collection device 10.

The data compiling unit 112 may store, in the chronological data storage unit 15 which will be described later, the individual pieces of periodic data and sporadic data after the provision of the time stamps.

The chronological data alignment unit 113 collects and aligns, based on the time stamps provided to the periodic data and the time stamp provided to the sporadic data, the periodic data and the sporadic data so as to convert the periodic data and the sporadic data into chronological data.

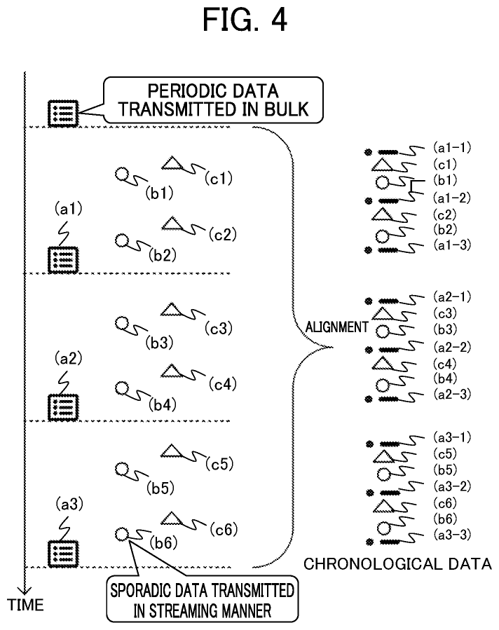

FIG. 4 is a schematic diagram showing the functions of the data compiling unit 112 and the chronological data alignment unit 113. As shown in FIG. 3(a1), a plurality of pieces of periodic data are assumed to be collected and transferred in bulk. In FIG. 3, as an example, one piece of bulk data (a1) is assumed to include three pieces of periodic data (a1-1) to (a1-3). In FIG. 4, as sporadic data, pieces of first sporadic data (b1) and (b2) and pieces of second sporadic data (c1) and (c2) are assumed to be transferred in a streaming manner.

The data compiling unit 112 divides the bulk data (a1) into individual pieces of periodic data (a1-1) to (a1-3), and individually provides time stamps to the pieces of periodic data (a1-1) to (a1-3). The data compiling unit 112 individually provides time stamps to the pieces of first sporadic data (b1) and (b2) and the pieces of second sporadic data (c1) and (c2).

The chronological data alignment unit 113 collects and aligns, based on the time stamps provided thereto, the pieces of periodic data (a1-1) to (a1-3), the pieces of first sporadic data (b1) and (b2) and the pieces of second sporadic data (c1) and (c2) so as to convert them into chronological data. In an example shown in FIG. 4, the chronological data alignment unit 113 sequentially aligns (a1-1), (c1), (b1), (a1-2), (c2), (b2) and (a1-3) so as to convert them into the chronological data.

Likewise, the data compiling unit 112 divides bulk data (a2) into individual pieces of periodic data (a2-1) to (a2-3), and individually provides time stamps to the pieces of periodic data (a2-1) to (a2-3). The data compiling unit 112 individually provides time stamps to the pieces of first sporadic data (b3) and (b4) and the pieces of second sporadic data (c3) and (c4). The chronological data alignment unit 113 collects and aligns, based on the time stamp provided thereto, the pieces of periodic data (a2-1) to (a2-3), the pieces of first sporadic data (b3) and (b4) and the pieces of second sporadic data (c3) and (c4) so as to convert them into chronological data. In other words, in the example shown in FIG. 4, the chronological data alignment unit 113 sequentially aligns (a2-1), (c3), (b3), (a2-2), (c4), (b4) and (a2-3) so as to convert them into the chronological data.

The chronological data transmission unit 114 transmits the chronological data to the outside of the data collection device 10. For example, the chronological data transmission unit 114 can transmit the chronological data to a display device which displays the chronological data as a list with a vertical axis or a horizontal axis representing time.

The chronological data storage unit 15 stores the chronological data. In the data collection device 10, the chronological data storage unit 15 does not need to be an essential constituent element.

### 3 Operation of Data Collection Device

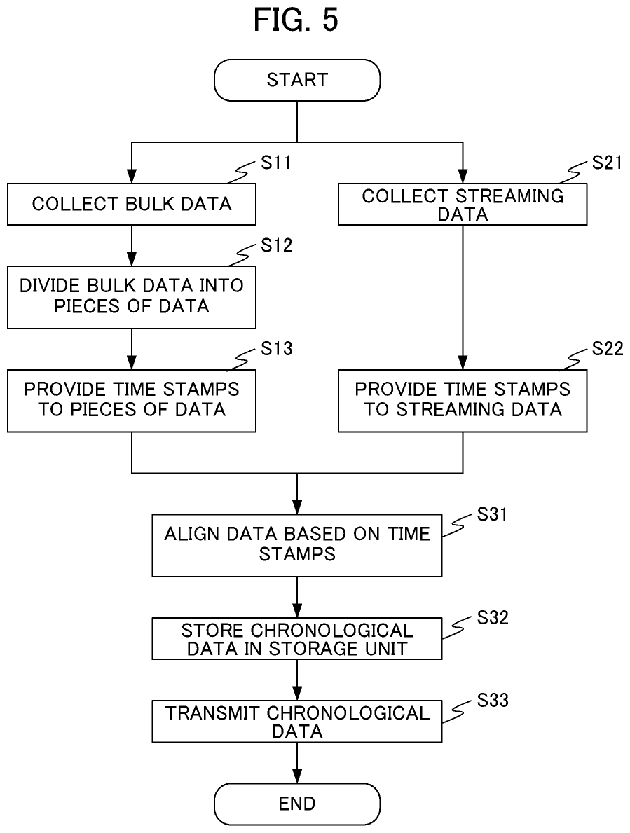

FIG. 5 is a flowchart showing the operation of the data collection device 10. Although here, the data collection device 10 is assumed to include only two data collection units which are the first data collection unit 111a and the second data collection unit 111b, there is no limitation to this configuration. In step S11, the first data collection unit 111a collects bulk data which is transmitted in bulk.

In step S12, the data compiling unit 112 divides the bulk data into individual pieces of periodic data.

In step S13, the data compiling unit 112 provides time stamps to the individual pieces of periodic data.

In step S21, the second data collection unit 111b collects streaming data which is transmitted in a streaming manner.

In step S22, the data compiling unit 112 individually provides time stamps to pieces of sporadic data which are the streaming data.

In step S31, the chronological data alignment unit 113 chronologically collects and aligns the pieces of periodic data and the pieces of sporadic data based on the time stamps provided thereto so as to convert them into chronological data.

In step S32, the chronological data storage unit 15 stores the chronological data.

In step S33, the chronological data transmission unit 114 transmits the chronological data stored in the chronological data storage unit 15 to an external device of the data collection device 10, for example, the display device.

Although in the flowchart of FIG. 5, the processing from steps S11 to S13 and the processing from steps S21 and S22 are shown so as to be performed parallel to each other, there is no limitation to this configuration. For example, the processing from steps S11 to S13 and the processing from steps S21 and S22 can be linearly performed.

Although in the flowchart of FIG. 5, as step S32, the processing for storing the chronological data in the chronological data storage unit 15 is indicated, there is no limitation to this configuration. For example, a configuration may be adopted in which step S32 is omitted, in which the chronological data alignment unit 113 converts the pieces of periodic data and the pieces of sporadic data into the chronological data and in which the converted chronological data is transmitted by the chronological data transmission unit 114 to the external device of the data collection device 10 without being stored in the chronological data storage unit 15.

### 4. Specific Example

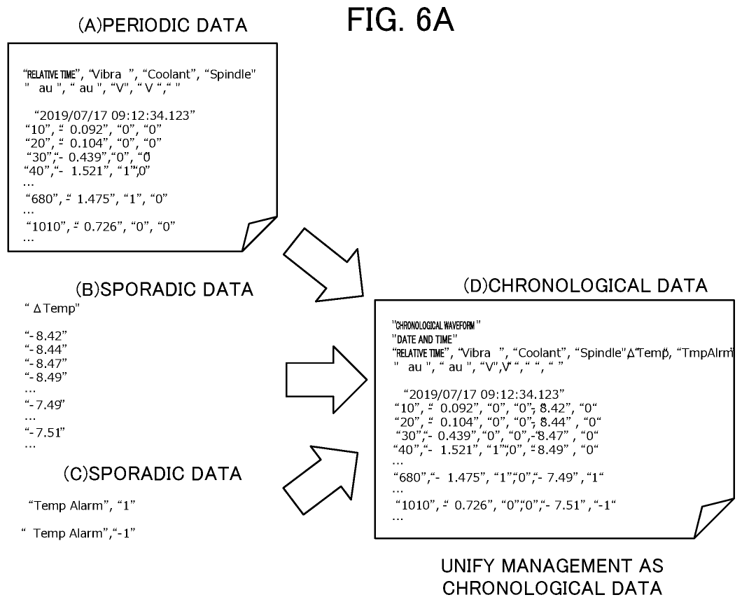

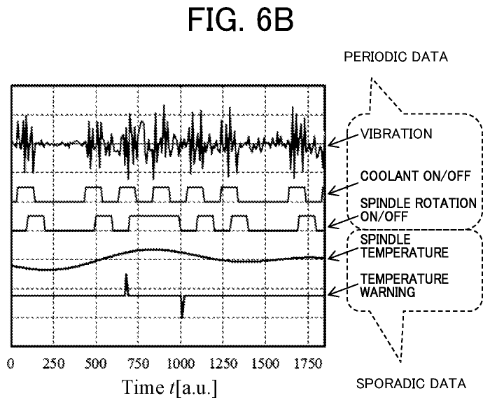

FIGS. 6A and 6B are diagrams showing a specific example of the operation of the data collection device 10. Data (A) is an example of the periodic data included in the bulk data collected by the first data collection unit 111a. In an example shown in FIG. 6A, the data (A) includes position data indicating the vibration of the spindle, data indicating that the coolant is turned on or off and data indicating that the rotation of the spindle is turned on or off, and is transmitted in bulk to the first data collection unit 111a from the manufacturing device 20 together with time stamps indicating relative times after the first data acquisition time.

Data (B) is an example of the first sporadic data collected by the second data collection unit 111b. In the example shown in FIG. 6A, the data (B) is data indicating a variation in the temperature of the spindle, and is transmitted in a streaming manner from the manufacturing device 20 to the second data collection unit 111b without time stamps being provided thereto.

Data (C) is an example of the second sporadic data collected by a third data collection unit 111c. In the example shown in FIG. 6A, the data (C) is data indicating a warning for providing notification that the temperature of the spindle exceeds a predetermined range or drops below it, and is transmitted in a streaming manner from the manufacturing device 20 to the third data collection unit 111c without time stamps being provided thereto.

The data compiling unit 112 divides the data (A) into individual pieces of periodic data, and uses time stamps which are provided in the manufacturing device 20 to individual pieces of data and which indicate the relative times so as to provide, to the individual pieces of data, time stamps indicating the acquisition times themselves when the pieces of data are acquired in the manufacturing device 20.

The data compiling unit 112 further provides, to the data (B) and the data (C), time stamps indicating times when they are received in the data collection device 10.

The chronological data alignment unit 113 collects and aligns the individual pieces of periodic data and the pieces of sporadic data based on the time stamps so as to convert them into data (D) which is chronological data. Although in the example shown in FIG. 6A, the sporadic data (B) and the sporadic data (C) are inserted into portions in which times when they are collected agree with the acquisition times of the individual pieces of periodic data included in the data (A), there is no limitation to this configuration. For example, when the times when the sporadic data (B) and the sporadic data (C) are collected are intermediate between the acquisition times of two continuous pieces of periodic data, the sporadic data (B) and the sporadic data (C) may be inserted between these two continuous pieces of periodic data.

The chronological data transmission unit 114 transmits the data (D) which is chronological data to the external device of the data collection device 10. In an example shown in FIG. 6B, the chronological data transmission unit 114 transmits the data (D) to the display device which is present outside the data collection device 10. Consequently, as shown in FIG. 6B, in the display device, with a horizontal axis representing time, the position data indicating the vibration, the data indicating that the coolant is turned on or off and the data indicating that the rotation of the spindle is turned on or off which are the periodic data and data indicating the temperature of the spindle and data indicating a temperature warning which are the sporadic data are displayed as a list.

### 5 Effects Achieved in Embodiment

The data collection device 10 according to the present embodiment includes: the first data collection unit 111a that receives bulk data in which a plurality of pieces of data acquired periodically are collected and transferred in bulk; a second data collection unit 111b that receives streaming data in which, each time a piece of data is acquired sporadically, the piece of data is transferred in a streaming manner; a data compiling unit 112 that divides the pieces of data received collectively and included in the bulk data into individual pieces of data so as to individually provide time stamps to the individual pieces of periodic data and that individually provides time stamps to the pieces of sporadic data which are streaming data; and a chronological data alignment unit 113 that collects and aligns the individual pieces of periodic data and the pieces of sporadic data based on the time stamps so as to convert them into chronological data.

In this way, it is possible to compile a plurality of types of data that include the data of bulk transfer in which data occurring periodically in the manufacturing device is collected and transmitted and the data of streaming transfer in which, each time data occurs sporadically, the data is transmitted. Furthermore, the bulk data and the streaming data collected from the manufacturing device are converted into the chronological data which is aligned based on the time stamps, and thus it is easy to draw sensor data in real time with a vertical axis or a horizontal axis representing time so as to use it for a monitoring application and to perform analysis for examining a correlation between various types of sensor values within a certain time.

In the data collection device 10, the time stamps that are provided to data included in the bulk data and acquired periodically are time stamps at times when the data is acquired in the manufacturing device.

In this way, it is possible to compile data based on the time stamps useful for grasping the operation conditions of the manufacturing device which is a data collection source.

In the data collection device 10, the time stamps that are provided to data acquired sporadically as streaming data are time stamps at times when the data is acquired in the manufacturing device.

In this way, it is possible to compile data based on the time stamps useful for grasping the operation conditions of the manufacturing device which is a data collection source.

In the data collection device 10, the time stamps that are provided to data acquired sporadically as streaming data are time stamps at times when the data is received in the data collection device 10.

In this way, even when time stamps are not provided to sporadic data on the side of the manufacturing device, it is possible to chronologically align and compile the bulk data and the streaming data.

The data collection device 10 further includes the chronological data transmission unit 114 that transmits the chronological data to a display device which displays the chronological data.

In this way, it is possible to display, as a list, the bulk data and the streaming data which are compiled as the chronological data.

The data collection device 10 further includes the chronological data storage unit 115 which stores the chronological data.

In this way, the data collection device 10 can temporarily store the chronological data when it is not necessary to transmit the chronological data to an external device immediately after the bulk data and the streaming data are converted into the chronological data.

Individual constituent units included in the data collection device 10 and the data collection system 1 described above can be realized by hardware, software or a combination thereof. A data collection method which is performed by the coordination of the individual constituent units included in the data collection device 10 and the data collection system 1 described above can also be realized by hardware, software or a combination thereof. Here, the realization by software means that a computer reads and executes programs so as to achieve the realization.

Programs are stored with various types of non-transitory computer readable media and can be supplied to a computer. The non-transitory computer readable media include various types of tangible recording media (tangible storage media). Examples of the non-transitory computer readable medium include magnetic recording media (for example, a flexible disk, a magnetic tape and a hard disk drive), magneto-optical recording media (for example, a magneto-optical disk), a CD-ROM (Read Only Memory), a CD-R, a CD-R/W and semiconductor memories (for example, a mask ROM, a PROM (Programmable ROM), an EPROM (Erasable PROM), a flash ROM and a RAM (random access memory)). Programs may also be supplied to a computer with various types of transitory computer readable media. Examples of the transitory computer readable medium include electrical signals, optical signals and electromagnetic waves. The transitory computer readable medium can supply programs to a computer through a wired communication path such as an electric wire or an optical fiber or a wireless communication path.

### EXPLANATION OF REFERENCE NUMERALS

1 data collection system
10 data collection device
11 control unit
15 chronological data storage unit
20 manufacturing device
21 numerical controller
22 machine tool
23 sensor
24 state monitoring device
111a first data collection unit
111b second data collection unit
111n nth data collection unit
112 data compiling unit
113 chronological data alignment unit
114 chronological data transmission unit

What is claimed is:

1. A data collection device comprising: a first data collection unit that receives bulk data in which a plurality of pieces of first data acquired periodically in a manufacturing device are collected and transferred in bulk;
a second data collection unit that receives streaming data in which, each time a piece of second data is acquired sporadically in the manufacturing device, the piece of second data is transferred in a streaming manner;
a data compiling unit that divides the pieces of first data received collectively and included in the bulk data into individual pieces of data so as to individually provide time stamps to the pieces of first data and that individually provides time stamps to the pieces of second data; and
a chronological data alignment unit that aligns the pieces of first data and the pieces of second data based on the time stamps so as to convert the pieces of first data and the pieces of second data into chronological data.

2. The data collection device according to claim 1, wherein the time stamps of the pieces of first data are time stamps at times when the pieces of first data are acquired in the manufacturing device.

3. The data collection device according to claim 1, wherein the time stamps of the pieces of second data are time stamps at times when the pieces of second data are acquired in the manufacturing device.

4. The data collection device according to claim 1, wherein the time stamps of the pieces of second data are time stamps at times when the pieces of second data are received in the data collection device.

5. The data collection device according to claim 1, further comprising: a chronological data transmission unit that transmits the chronological data to a display device which displays the chronological data.

6. The data collection device according to claim 1, further comprising: a chronological data storage unit that stores the chronological data.
